(19) United States
(12) Patent Application Publication
(10) Pub. No.: US 2022/0211021 A1
(43) Pub. Date: Jul. 7, 2022

(54) FISHHOOK REMOVAL DEVICE AND METHOD

(71) Applicant: Paul Miller, Ocean Springs, MS (US)

(72) Inventor: Paul Miller, Ocean Springs, MS (US)

(21) Appl. No.: 17/142,915

(22) Filed: Jan. 6, 2021

(51) Int. Cl. A01K 97/18; B25B 7/22; B25B 7/02

(52) U.S. Cl. CPC A01K 97/18; B25B 7/02; B25B 7/22

(57) ABSTRACT

A fishhook removal device and method for removal of a fishhook from the mouth of a fish with minimal damage to the fish and minimal danger of the user becoming injured during removal of the fishhook, providing a fishhook removal device having a pliers body, two pliers handles, two pliers jaws, and a hooked rounded extension fixed to a pliers jaw, where, in use, the hooked rounded extension is placed into the bend of the fishhook while the fishing line is held taught from the direction generally forward of the fish, the fishhook removal device is twisted and pulled away from the fish, and the fishhook is removed.

### BACKGROUND OF THE INVENTION

This invention provides a fishhook removal device and method for removal of a fishhook from the mouth of a fish with minimal damage to the fish and minimal danger of the user becoming injured during removal of the fishhook.

Removal of a fishhook from the mouth of a fish can be a difficult and somewhat dangerous task with some risk of damaging the fish, where it may be desired to release the fish or keep the fish intact, and with some risk of injury to the person attempting to remove the fishhook, such as being pierced by the fishhook or otherwise injured by a flailing fish.

What is needed is a fishhook removal device and method providing easy removal of a fishhook with minimal damage to the fish and minimal chance of injury to the person removing the fishhook.

Japanese Patent No. 3,144,839 for “Fishing Scissors,” issued on Sep. 18, 2008 to — [symbol] , provides for a scissors instrument having a pair of scissors that open and close on the front side, and manually opening and closing the scissors on the handle parts. Sharpened, a semicircular concave is formed inside the tip, and concave and convex teeth are formed at an angle to the front, and a non-slip portion is formed by sharpening.

French Patent Application Publication No. 2,599,937 for “Pliers Serving for Unhooking an Artificial Fly or Hook Which is Used for Fishing,” published on Dec. 18, 1987 by inventor Bruno Audebert, discloses pliers for fishing, the pliers consisting of two handles and two jaws. The jaws form a rounding starting from the base to end in a bend from 1800 to the end, while continuing the rounding.

U.S. Pat. No. 2,152,879 for a “Fishhook Disgorger,” issued on Apr. 4, 1939 to inventor Benjamin L. Dorsey, provides for a fishhook disgorging implement that is formed in a single piece and which device, after being guided into engagement with the hook by the leader or line to which said hook is connected, is rotated so as to disengage or release the hook from the fish and permit said hook to be withdrawn.

U.S. Patent Application Publication No. 2008/0120894 for a “Fish Hook Remover,” published on May 29, 2008 by inventor Norman L. Broadnax, discloses a tool for removing a fish hook, the tool has an elongated handle with a longitudinal axis, top and bottom end portions and a middle portion intermediate the top and bottom end portions. A shoulder connected to the top end portion has first and second portions offset from the longitudinal axis. A first hook engaging member joined to the first portion of the shoulder angularly extends toward the longitudinal axis. The first hook engaging member has an inner surface defining a plurality of grooves therein adapted to engage the fishhook to facilitate removal thereof from the fish's mouth.

U.S. Pat. No. 2,779,123 for a “Fishhook Extractor,” issued on Jan. 29, 1957 to assignee Arthur A. Tellier et al., provides for a fish hook extracting tool utilizing a plier principle, affording firm positive grip and control of an imbedded fish hook, and having a passageway formed between the jaws of the tool for loosely receiving and confining a fish line or leader to guide the tool to the hook when the same is obscured from view.

U.S. Pat. No. 6,205,699 for a “Fish Hook Remover,” issued on Mar. 27, 2001 to inventor Fabio Bogni, provides for a fishhook remover for removing a fishhook from a fish without damaging dressing affixed to the fish hook. The fishhook remover includes a pair of arms pivotally mounted to one another. Each of the arms defines a first end and a second end. A hook member extends from the first end of each arm at a selected angle and a handle extends from the second end of each arm. The hook members extend from the arms in a manner such that the bend of the fishhook can be gripped between the terminating ends of the hook members without disturbing the dressing.

U.S. Pat. No. 3,778,919 for “Hook Extractor Pliers,” issued on Dec. 18, 1973 to inventor James O. Simon, provides for hook extractor pliers having a push-plate on one of the jaws thereof, the plate facing toward the other pliers jaw which has a slot therein for accommodating the plate. A notch provided at the base of the plate permits the pliers to be guided along the shank of the hook and moved toward the bent portion thereof for disconnecting the hook from the mouth of the fish after which the jaws are closed to firmly grasp the hook therebetween for completely removing the hook from the fish.

U.S. Pat. No. 7,434,350 for a “Two-Handed Fish Hook Removal Apparatus,” issued on Oct. 14, 2008 to inventors Jerry J. Gomez, Sr. et al., provides for a fishhook removal apparatus including a shaft having opposed end portions. One end portion defines a hook for fitting into a fish's mouth. Such a hook is engageable with a fishhook. The shaft enables a user to remove a hook from fish. A grip is positioned about another end portion. Such a grip includes indentations spaced along a length of the grip allowing for a firm grasp. A clevis is attached to the shaft and situated proximate to the grip. A handle includes body and rod portions. Such a rod portion has opposed end portions. The body portion is positioned about one end of the rod extending from the body. The handle is abutted against the shaft in such a manner that rotation of the handle causes the hook to twist about a fishing hook lodged within the fish's mouth, thereby dislodging the fishing hook.

### SUMMARY OF THE INVENTION

This invention provides a fishhook removal device and method for removal of a fishhook from the mouth of a fish with minimal damage to the fish and minimal danger of the user becoming injured during removal of the fishhook. A fishhook removal device is provided having a pliers body, two pliers handles, two pliers jaws, and a hooked rounded extension fixed to a pliers jaw. In use, the hooked rounded extension is placed into the bend of the fishhook while the fishing line is held taught from the direction generally forward of the fish, the fishhook removal device is twisted and pulled away from the fish, and the fishhook is removed.

### BRIEF DESCRIPTION OF THE DRAWINGS

Reference will now be made to the drawings, wherein like parts are designated by like numerals, and wherein:

FIG. 1 is a top view of the fishhook removal device of the invention;

FIG. 2 is a perspective view of the fishhook removal device of the invention;

FIG. 3 is a schematic view of the fishhook removal device of the invention in use before removal of the fishhook; and

FIG. 4 is a schematic view of the fishhook removal device of the invention in use during removal of the fishhook.

### DETAILED DESCRIPTION OF THE INVENTION

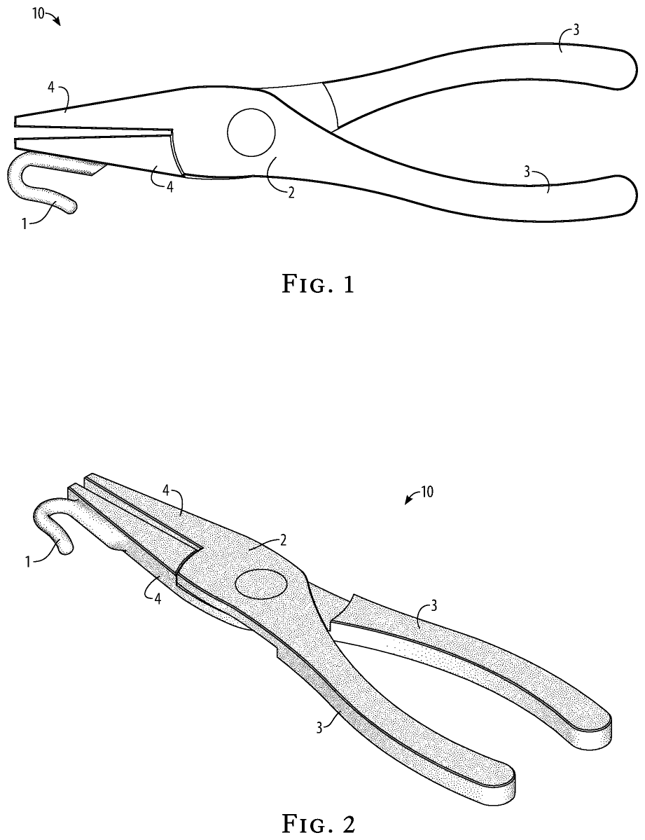

Referring to FIG. 1, the fishhook removal device 10 provides a pliers body 2 having pliers handles 3 toward the back and pliers jaws 4 toward the front, and provides a hooked rounded extension 1 fixed to one of the pliers jaws 4, as shown and disclosed herein. The pliers body 2 can be made of metal or hard plastic, and the hooked rounded extension 1 can also be made of metal or hard plastic. The pliers body 2 and hooked rounded extension 1 can be made of the same material or of different materials. Using the same material for both can provide some advantages in the process of fixing the hooked rounded extension 1 to the pliers jaw 4 during manufacture. If a metal is used, a rustproof metal is preferable for the conditions of use. If a hard plastic is used, the pliers body might optionally be made to float if dropped in the water. The pliers body 2 has a flatter or broader plane in which the pliers jaws 4 travel.

Referring additionally to FIG. 2, the hooked rounded extension 1 has a rounded form in cross section, such as a thick wire. The hooked rounded extension 1 is fixed to one of the pliers jaws 4 as is appropriate for the materials used, such as welding or otherwise bonding one to the other. The hooked rounded extension 1 extends toward the front of the pliers jaw 4 and then curves away from the pliers jaw 4, in the plane of jaws travel, in a curve which forms a hook in the hooked rounded extension 1. The hooked rounded extension 1 has a fixed end, an intermediate curve, and a free end.

The dimensions of the fishhook removal device 10 generally correspond to the range of sizes of the fishhooks expected to be used. A typical fishhook has a shank with an eye at one end, a bend, and a free end leading to the point, with the distance from the bend to the point called the throat. The gap or gape is the distance between the shank and the free end, or roughly the diameter of the bend in a typical fishhook. Working prototypes of the fishhook removal device 10 were developed and tested for gulf redfish or red drum using hooks of generally a 1/0 hook size, having a gap of roughly 12 mm to 0.5″, which is a very common hook size. The gap size of slightly smaller, such as #1, #2, and #4, and slightly larger, such as 2/0, 3/0, and 4/0, fishhooks do not change very much from the roughly 12 mm to 0.5″ of the size 1/0 fishhook. The intermediate-curve portion of the hooked rounded extension 1 is meant to fit into the gap of a fishhook and, when twisted as treated below, apply a force in one direction to the shank of the fishhook and a force in the opposite direction to the free end of the fishhook. With a larger diameter of the hooked rounded extension 1, the shank and free end of the fishhook will make contact and apply force with less twisting motion required. But if the diameter of the hooked rounded extension 1 is made too large, placement of the hooked rounded extension 1 into the bend of the fishhook will become more difficult. For typical fishing using 1/0 size hooks or slightly smaller or slightly larger hooks with a gap of roughly 12 mm to one-half inch, a diameter of approximately one-third to one-half of the gap size, which is approximately 4 mm to 6 mm or 3/16″ to ¼″, is appropriate for the hooked rounded extension.

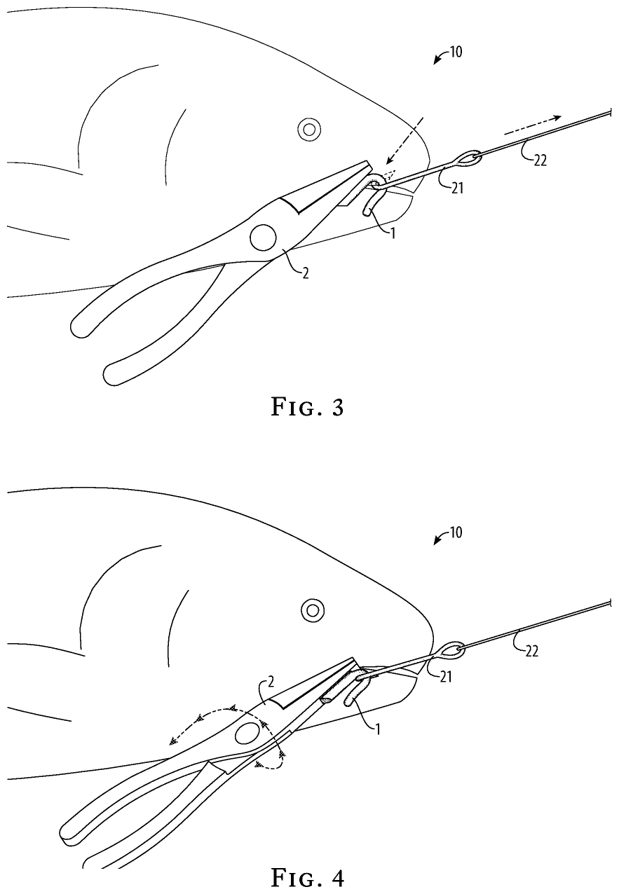

Referring to FIG. 3, the fishhook removal device 10 is used on a fish having in its mouth a fishhook 21 attached to a fishing line 22. In use, the user grasps the fishing line 22 with the hand not holding the fishhook removal device 10 and pulls the fishing line 22 taught in the direction generally forward of the fish. The user also places the hooked rounded extension 1 of the fishhook removal device 10 into the bend of the fishhook 21. If the fishhook is embedded in the upper part of the fish's mouth, then the fishhook removal device 10 is placed with the hooked rounded extension 1 pointing generally downward in relation to the fish. If the fishhook is embedded in the lower part of the fish's mouth, then the fishhook removal device 10 is placed with the hooked rounded extension 1 pointing generally upward in relation to the fish. Another way of stating the positioning of the fishhook removal device 10 is that the pliers body 2 is placed toward the jaw that is hooked, with the hooked rounded extension 1 facing generally toward the open mouth of the fish.

Referring to FIG. 4, in use, while the user maintains a taught pull on the fishing line 22, the fishhook removal device 10 is twisted and pulled away from the fish, as shown. The twisting motion is along the front-to-back axis of the pliers body 2, and is such that the pliers body 2 is pushed against the fish and the hooked rounded extension 1 is pulled away from the fish. Where the fishhook is embedded in the fish's upper mouth, the twisting will be counterclockwise, and where the fishhook is embedded in the fish's lower mouth, the twisting will be clockwise. The pulling-away motion is pulling in a direction generally opposite the direction of the point and the eye of the fishhook.

In use, with the hooked rounded extension 1 of the fishhook removal device 10 properly placed into the bend of the fishhook 21 and with the fishing line 22 being pulled generally forward of the mouth of the fish, the proper twisting motion of the fishhook removal device 10 will bring one portion of the hooked rounded extension 1 into contact with and exerting force on the shank side of the bend of the fishhook 21 while simultaneously making contact with and exerting force on the point side of the bend of the fishhook 21. The rounded profile of the hooked rounded extension 1 facilitates contact with the fishhook 21 and adapts to changes in the position and angle of the fishhook removal device 10 by creating a rolling contact between the fishhook 21 and the hooked rounded extension 1. The force exerted on the fishhook 21 by the hooked rounded extension 1 being twisted is a force tending to remove the fishhook from the mouth of the fish. The pulling-away motion also causes the hooked rounded extension 1 to exert force against the bend of the fishhook, where this force also tends to remove the fishhook from the mouth of the fish. With the combined twisting and pulling actions, the fishhook is removed from the mouth of the fish with a minimal amount of damage to the fish and with minimal danger of the user becoming injured during removal of the fishhook.

Many other changes and modifications can be made in the system and method of the present invention without departing from the spirit thereof. I therefore pray that my rights to the present invention be limited only by the scope of the appended claims.

I claim:

1. A fishhook removal device for removal from a mouth of a fish of a fishhook having an eye with fishing line attached, a shank, a bend, and a free end having a point, the fishhook removal device comprising:
(i) a pliers body having a front and a back, with two pliers handles toward the back and two pliers jaws toward the front, each said pliers jaw having an inner face and an opposite outer face, and having a plane of jaw travel;
(ii) a hooked rounded extension fixed to one said pliers jaw on an outer face, extending frontwards and curving outwards and backwards in the plane of jaw travel, forming a hook adapted to, in use, engage the bend of the fishhook and place force upon the fishhook.

2. The fishhook removal device of claim 1, where said pliers body is made of metal.

3. The fishhook removal device of claim 1, where said pliers body is made of a plastic.

4. The fishhook removal device of claim 1, where said pliers body is further adapted to float on water.

5. The fishhook removal device of claim 1, where said hooked rounded extension has a diameter of from 4 mm to 6 mm.

6. The fishhook removal device of claim 1, where said hooked rounded extension has a diameter of from 3/16″ to ¼″.

7. A fishhook removal method for removal from a mouth of a fish of a fishhook having an eye with fishing line attached, a shank, a bend, and a free end having a point, the fishhook removal method comprising:
(i) providing a fishhook removal device comprising:
(a) a pliers body having a front and a back, with two pliers handles toward the back and two pliers jaws toward the front, each said pliers jaw having an inner face and an opposite outer face, and having a plane of jaw travel; and
(b) a hooked rounded extension fixed to one said pliers jaw on an outer face, extending frontwards and curving outwards and backwards in the plane of jaw travel, forming a hook adapted to, in use, engage the bend of the fishhook and place force upon the fishhook;
(ii) pulling the fishing line taught in a direction generally forward of the fish;
(iii) placing said fishhook removal device on the fishhook with said hooked rounded extension against the inside of the bend of the fishhook;
(iv) twisting and pulling away said fishhook removal device, thereby placing force against the fishhook; and
(v) removing the fishhook from the mouth of the fish.

8. The fishhook removal method of claim 7, where said pliers body is made of metal.

9. The fishhook removal method of claim 7, where said pliers body is made of a plastic.

10. The fishhook removal method of claim 7, where said pliers body is further adapted to float on water.

11. The fishhook removal method of claim 7, where said hooked rounded extension has a diameter of from 4 mm to 6 mm.

12. The fishhook removal method of claim 7, where said hooked rounded extension has a diameter of from 3/16″ to ¼″.
